(19) United States
(12) Patent Application Publication
(10) Pub. No.: US 2001/0037360 A1
(43) Pub. Date: Nov. 1, 2001

(54) Data service at a transit terminal

(75) Inventor: Frederik Ekkel, Cupertino, CA (US)

Correspondence Address: Edward Blocker, Philips Electronics North America Corporation, 580 White Plains Road, Torrytown, NY, 10591, US

(73) Assignee: KONINKLIJKE PHILIPS ELECTRONICS N.V.

(21) Appl. No.: 09/784,622

(22) Filed: Feb. 14, 2001

Related U.S. Application Data
(60) Provisional application No. 60/204,059, filed on May 12, 2000.

(51) Int. Cl. G06F 15/16

(52) U.S. Cl. 709/203; 709/219

(57) ABSTRACT

A method provides a traveler access to a repository over an information network by means of an access point apparatus located at a transit terminal. The traveler can download information content hosted on the repository for off-line viewing. The downloaded information content is stored on a mobile storage medium. The storage medium is given to the traveler and may be used later by the traveler to access the data, when traveling for example. The information content may also be downloaded onto a storage medium being an onboard component of a means of transportation. The traveler accesses the information network using a device provided at an assigned traveling location.

### FIELD OF THE INVENTION

The invention concerns a method of providing to an individual off-line access to information content.

The invention further relates to an access-point apparatus providing access to an information network.

The invention also relates to a storage medium with pre-stored information content.

The invention may be used to provide updated broadcast news to a traveler before traveling.

### BACKGROUND ART

Inflight entertainment is a growing market segment, which incorporates different technologies to offer an increasing number of products and services to travelers. A non-profit organization, the World Airline Entertainment Association (WAEA), has been founded for representing over 100 airlines and 300 airlines suppliers. The WAEA seeks for a continual improvement of the service offered to the traveler and of the traveler's environment. Some airlines provide their travelers with individual monitors mounted on the seats that offer various interactive features. These features comprise news-update, personal video-cassette players, telephone, electronic mail services, computers link-up, etc. . . .

### SUMMARY OF THE INVENTION

Very often public means of transportation do not offer live connection to public information networks. Due to this technical limitation, a traveler has rarely access to the most current version of information content. This lack of connection implies that a limited number of non-customized features are offered to all travelers.

It is an object of the invention to provide to a traveling individual off-line access to information content normally available on-line.

To this end, a method of the invention comprises:

at a transit terminal, providing access over an information network to a repository hosting the information content;

at the transit terminal, enabling to transfer the information content over the network from the repository to a mobile storage medium;

providing the storage medium to the individual.

Thus, before boarding the individual has, for example, the possibility of downloading the most up-to-date version of information content from a network for offline viewing when traveling. The invention advantageously provides the individual with the most recent version of given electronic information content. Such a method gives an alternative to the traditional newspaper following the trend towards electronic communication media.

Such a method may be user-customized. Information content may be determined from a user profile built in advance from preferences given by the user at the time of booking.

According to the invention, a method of providing to the individual access to the information content, comprises:

at a transit terminal, providing access over an information network to a repository hosting the information content;

at the transit terminal, enabling to transfer the information content over the network between the repository and a mobile storage medium;

assigning a traveling location to the individual in a means of transportation, the means of transportation including the mobile storage medium;

providing at the assigned traveling location an apparatus to enable the individual to access the information content.

In the invention the storage medium may be a component onboard of the means of transportation. The individual is assigned a traveling location, e.g., a seat or a cabin, that is equipped with an apparatus that permits the individual to access the information content. The individual may access information content through a local network of the means of transportation that includes the storage medium.

Further the access point apparatus of the invention comprises:

a connecting unit to access over the information network a repository hosting an information content;

a receiving unit to receive a removable storage medium; and,

a transfer unit, coupled to the connecting unit and the receiving unit, enabling to transfer the information content from the repository to the removable storage medium.

The access point apparatus or “kiosk” may be placed in terminals. Such an apparatus permits to download information content on the storage medium which is then given to the traveler for later use for off-line browsing of the content.

### BRIEF DESCRIPTION OF THE DRAWING

The invention is explained in further detail, by way of example, and with reference to the accompanying drawing wherein:

FIG. 1 is a flow-chart of a method of the invention;

FIG. 2 is a block diagram of an apparatus of the invention;

FIG. 3 is a flow-chart of a method of the invention; and

FIG. 4 is a flow-chart of a method of the invention.

### PREFERRED EMBODIMENT

The invention relates to a service provided to a traveler at a transit terminal. An individual may travel from a departing point to a destination point using various means of transportation, e.g., a car, a bus, an aircraft, a ship, a train, etc. . . . A “transit terminal”, as used herein, indicates a travel departing or arrival point such as an airport, a train station or a bus stop.

At the terminal, access is provided to an information network, e.g., the Internet or any other public or private information network. The individual may be allowed to use this access to download electronic information content from a host repository or server onto a mobile storage medium. For example, the individual downloads information content from the Internet for use later on when on a plane where no live access to the Internet is available.

Preferably, the service is highly customizable in the sense that the traveler is enabled to select among information contents offered at the terminal the one/ones that is/are interesting or relevant to this traveler. Selected information content gets downloaded on a mobile storage medium to which the individual has access when away from the terminal. Alternatively, or in addition, the individual has specified in advance his/her profile to, e.g., the service provider, or the travel agency, as part of the travel arrangement. Information content matching this profile is downloaded onto the mobile storage medium. For example, the individual has specified that he wants to have access to an electronic version of a current edition of a certain newspaper or magazine when the individual is traveling on a plane, or the most current version of a TV broadcast.

The mobile storage medium comprises, for example, a memory card or an optical or magnetic disk to be used with the laptop personal computer of the individual, or with a data processing apparatus provided onboard the means of transportation.

In a first embodiment, information content is stored onto the storage medium at the terminal, and the individual is given the storage medium to keep it with him/her.

In a second embodiment, the mobile storage medium comprises a component onboard the means of transportation used. For example, the storage medium is a component of a data network local to a train, ship or airplane. Once onboard, the individual is enabled to login to the local network with his/her PC for access to the selected information content.

In a third embodiment, the local network onboard the means of transportation comprises devices from which the individual accesses the selected information content. This has the advantage that the individual does not need to carry his/her own laptop PC. For example, each seat on a plane is provided with a data processing apparatus that has a display screen and other user-interface capabilities, e.g., a cursor control device or a keyboard, through which the individual can browse or otherwise interact with information content. The onboard access to the local network preferably also enables the individual to create email messages and other electronic documents. These messages and documents get cached locally on the local network until the means of transportation arrives at a destination transit terminal. At the terminal, the local network is connected to a terrestrial information network to which the messages or documents are transferred and electronically sent to their addressees' recipients.

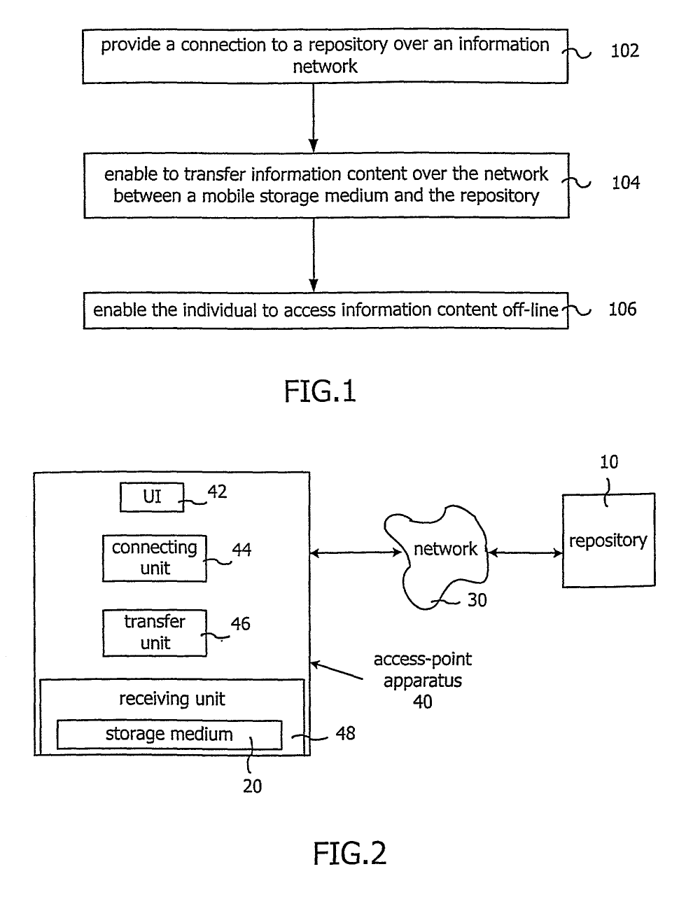

The above and other concepts are further explained in more detail below with reference to FIG. 1-3.

FIG. 1 is a flow-chart giving possible steps of a method of the invention. A first step 102 comprises enabling an individual to access a repository 10 from an access-point apparatus 40 at a transit terminal. Access to the repository 10 is provided over an information network 30. The repository 10 is configured to host information content C. The repository 10 may be a server or a database from which information content C can be retrieved upon request by a server over the Internet.

A second step 104 comprises transferring information content C from the repository 10 to a mobile storage medium 20. Information content C is downloaded over the network 30 to the medium 20.

In a third step 106, the individual is enabled to access information content C from the storage medium 20. In step 106, the individual is provided with the storage medium 20. The individual uses the mobile storage medium 20 to render information content C off-line.

Enabling the traveler to access information content C may comprise supplying information content C using a widely spread data format, e.g., MPEG-2 encoded video information content, MPEG-1 layer 3 audio content. Information content C may therefore be easily rendered user-readable. Step 106 may also comprise providing the traveler with a compatible apparatus for reading information content C from the medium 20. For example, travel companies may provide their means of transportation with individual monitors and processors mounted on the seats. Of the means of transportation.

FIG. 2 is an embodiment of the access point apparatus 40. The apparatus 40 offers to the individual using the apparatus 40 the possibility of exchanging data between the repository 10 and the storage medium 20.

In this embodiment, the apparatus 40 comprises a user interface 42 for enabling interactive communication between the traveler and the apparatus 40. For example, the interface 42 comprises a display monitor and a user-input device such as a keyboard or a cursor-control device.

The apparatus 40 further comprises a connecting unit 44 such as a modem or dialing unit for accessing the repository 10 over the network 30. Such a unit 44 may incorporate an internet browser supporting the TCP/IP protocol allowing World Wide Web content access. Access to the host repository 10 is done over terrestrial cable, over the air through antennas, and/or using satellites for example. The repository 10 is preferably remotely located and the repository 10 and the apparatus may be owned and managed independently from each other. The apparatus 40 can access the repository 10 when the individual requests the apparatus 40 to do so. In this case, the most current version of information content C hosted by the repository 10 is made available to the individual. Alternatively, the apparatus 40 may be set-up to access the repository 10 periodically, independently of any individual's request. Various information contents are retrieved and get cached locally on a proxy server or a cache server associated with the apparatus 40. Thus, when an individual requests given information content C, information content C is already present therefore allowing a faster download time for the individual.

The apparatus 40 comprises a receiving unit 48 for hosting the storage medium 20. The unit 48 may be any device hosting optical storage mediums such as a CD drive, a CD burner, a CD-RW, DVD-RW or DVD+RW player or a combination of these components. The apparatus 40 further comprises a transfer unit 46 for transferring and storing information content C on the storage medium 20. The storage medium 20 is for example an optical storage medium such as a CD, an optical disk, a hard-disk drive (HDD) or any other solid state storage medium such as a floppy disk, a MPEG-layer 3 memory, a memory unit of a mobile phone, a flash memory device (Memory Stick, SD card).

The unit 46 may also provide a wireless connection between the unit 48 hosting the storage medium 20 and the apparatus 40, e.g., enabling transfer of information content according to the WAP (Wireless Application Protocol) protocol. The WAP is a set of open, global protocols for developing applications and services that use wireless networks. The WAP protocols are mainly based on already existing Internet protocols, but are optimized for mobile users with wireless devices such as PDAs and cellular phones.

The apparatus 40 is placed in a transit terminal. The apparatus 40 is possibly an access point apparatus or a kiosk placed in a waiting lounge of a travel company in the transit terminal.

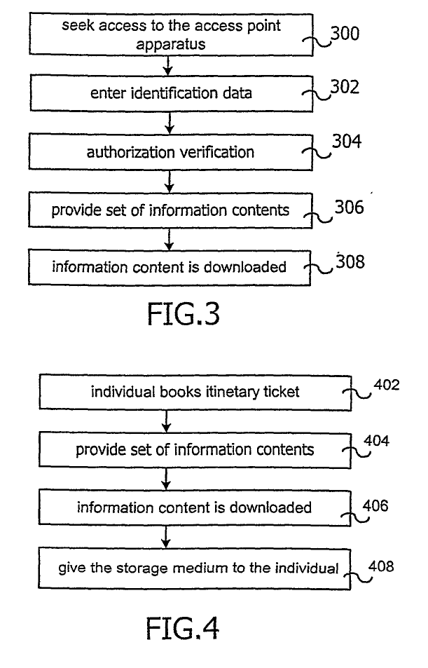

FIG. 3 is a flow-chart depicting a method of the invention. In a first step 300, the individual seeks access to the apparatus 40. A second step 302 comprises entering identification data ID through the user interface 42. The ID data is a Personal Identification Number (PIN) or a user name and a login password identifying the individual.

In a third step 304, the apparatus 40 checks whether the individual is authorized to access the apparatus 40 by comparing the entered ID data with stored authorized ID data. Authorized ID data may be stored remotely. Upon ID data matching, the individual is granted access to the access point 40. An authorized individual is, for example, a member of a frequent flyer program of an airline. Alternatively, the apparatus 40 is publicly accessible and the identification sub-process of step 302 and 304 does not exist.

In a fourth step 306, the UI 42 presents the individual with a choice of several information contents, which are available for download. The choice may appear as an interactive list on the UI 42 of the apparatus 40. Information content C may be a Web page such as News Web pages, financial Web pages giving the last-minute stock market's values, entertainment Web pages, etc. . . . Information content C may also be audio data or a movie to be downloaded for later viewing or listening.

Alternatively, the individual is not given the choice of information content C to be downloaded. In fact the apparatus 40 may allow downloading of a specific information content C only. For example, the apparatus 40 may allow downloading of the current version of a defined set of Web pages of the TIMES newspaper Web-site only. In this example, the apparatus 40 may be sponsored by the TIMES editor. Furthermore a given Web-site, such as the TIMES Web-site, may offer any individual to register for authorization to access and download pages of the Web-site at travel terminals. When the individual registers, the individual is given an identification code that can be used at a transit terminal to access the apparatus 40 and to download the current electronic version of the newspaper.

Furthermore, the set of information contents proposed to the individual may be defined based on a profile of the individual. The profile has been defined in advance and is associated to the individual's identification ID data. For example, when booking the travel ticket, the individual is asked for preferences of information content C. Thus, when gaining access to the apparatus 40, the individual is presented with the preferred information contents.

The profile may also define in advance a selection of information contents to be downloaded without any further choice needed from the individual at the time of travel. For example, when booking the travel ticket, the individual gives his selection of information content C that he wants to have downloaded. Just before boarding, the individual gains access to the apparatus 40 at the terminal by entering his identification ID data. The profile of the individual is retrieved and information content C matching the profile is requested from the host repository 10.

The definition of the profile may be done online at any time before boarding. As mentioned previously, the individual when booking his/her travel arrangement online may at the same time define a set of preferences as to the type of information contents. The profile may also be deduced from information on a personal home page or personal portal of the individual. Following this model, browsing the profile of the individual allows selecting information content for off-line browsing according to a method of the invention.

In a fifth step 308, information content C is downloaded onto the storage medium 20.

In the fifth step 308, the unit 48 downloads selected information content C to the storage medium 20. The storage medium 20 may be supplied by the apparatus 40. For example, the unit 46 comprises a CD burner and the apparatus 40 allows retrieving and burning information content C on an optical storage medium.

Another possible scenario for a method of the invention is given in FIG. 4. Firstly in step 402, the individual books his/her travel itinerary ticket, e.g., an airplane ticket. When making reservation and as shown in step 404, the individual is given the choice of sets of information contents, that, at the time of travel, will be available for downloading. The individual makes a selection. Just before boarding, information content C is downloaded as mentioned in step 406. In step 408, the transport company provides the individual with the storage medium 20 storing information content C that the individual has selected at the time of booking. For example, when the traveler checks-in before a flight, the airline company provides the individual with the storage medium 20, e.g. a CD-ROM or DVD (Digital Versatile Disk), together with the boarding card. Alternatively, at the entrance of the plane crew members may offer a variety of storage mediums 20 to the individuals traveling. For example, electronic versions of different newspapers may be handed out to the travelers entering the plane and each individual's seat is provided with a processing device for the individual to access the electronic information content from the storage medium 20. The individual may also be given a single storage medium 20 on which various information contents are stored, e.g., daily updated electronic editions of several newspapers.

In another embodiment, the apparatus 40 may allow downloading information content C a few minutes before the scheduled departure of the means of transportation without any request from the individual. Thus, when the individual has access to the apparatus 40, the storage medium 20 where information content C is stored is ready for pick up in the apparatus 40.

In an embodiment of the invention, a fee may apply for downloading information content C. In this case, the method comprises an additional step of supplying the requested fee for activating the download of information content C. The fee is possibly based on the actual size of content C to be downloaded or on the type of selected content C.

In another embodiment of the invention, the storage medium 20 is a component onboard the means of transportation. Before traveling, the storage medium 20 of the plane or the train is connected to the apparatus 40 that enables access to the repository 10. Information content C is transferred from the repository 10 to the storage medium 20. Often a traveler is assigned a specific location in the means of transportation, e.g. a seat in a train, a seat in an aircraft. Each seat may be provided with a display monitor and a processing unit thereby forming a local network in the means of transportation. The storage medium 20 is placed at a node of this local network and is made accessible to all the processing units at the seats. The individual has the possibility of viewing and browsing information content C directly from his seat when traveling. The storage medium 20 may also comprise specific memory units respectively associated to a given seat. The traveler may also be provided with a connection at his seat to plug a personal device, e.g. a laptop, enabling connecting to the local network.

It is to be noted that, with respect to the described method, modifications or improvements may be proposed without departing from the scope of the invention. For instance, it is clear that a method of the invention may be implemented in several manners, such as by means of wired electronic circuits or, alternatively, by means of a set of instructions stored in a computer-readable medium, said instructions replacing at least a part of said circuits and being executable under the control of a computer or a digital processor in order to carry out the same functions as fulfilled in said replaced circuits.

What is claimed is:

1. A method of providing to an individual access to an information content, the method comprising:
at a transit terminal, providing access over an information network to a repository hosting the information content;
at the transit terminal, enabling to transfer the information content over the network from the repository to a mobile storage medium; and,
providing the storage medium to the individual.

2. The method of claim 1, further comprising:
downloading the information content from the repository onto the mobile storage medium.

3. The method of claim 1, further comprising:
providing an apparatus at the transit terminal to allow the individual to cause the transfer of the information content.

4. The method of claim 1, wherein the information network comprises the Internet.

5. The method of claim 1, wherein transferring the information content is enabled over a wireless communication channel.

6. The method of claim 1, wherein the storage medium is an optical storage medium.

7. The method of claim 1, wherein the storage medium is provided to the individual when entering a means of transportation.

8. The method of claim 1, comprising:
identifying the individual;
upon identification, enabling the individual to select the information content from a plurality of information contents; and,
downloading the selected information content onto the mobile storage medium.

9. The method of claim 1, comprising:
enabling the individual to enter identification information;
selecting the information content based on the identification information; and,
downloading the information content.

10. The method of claim 1, wherein the information content is selected based on a profile of the individual.

11. A method of claim 1, comprising:
charging a fee for transferring the information content.

12. A method of providing to an individual access to an information content, the method comprising:
at a transit terminal, providing access over an information network to a repository hosting the information content;
at the transit terminal, enabling to transfer the information content over the network between the repository and a mobile storage medium;
assigning a traveling location to the individual in a means of transportation, the means of transportation including the mobile storage medium; and,
providing at the assigned traveling location an apparatus to enable the individual to access the information content.

13. The method of claim 12, wherein the information content is determined from a plurality of information contents on the basis of a profile of the individual.

14. An access point apparatus providing access to an information network, the apparatus comprising:
a connecting unit to access over the information network a repository hosting an information content;
a receiving part for receiving a removable storage medium; and
a transfer unit, coupled to the connecting unit and the receiving part, enabling to transfer the information content from the repository to the removable storage medium.

15. The apparatus of claim 14, wherein the information network comprises the Internet.

16. The apparatus of claim 14, wherein the transfer unit allows storing the information content as digital data onto the removable storage medium, the storage medium comprising an optical storage medium.

17. The apparatus of claim 14, wherein the apparatus enables an individual to retrieve the storage medium.

18. A storage medium with pre-stored electronic information content selected on the basis of a profile of an individual and for use with an apparatus on board a means of transportation to enable the individual access to the information content.
